(19) United States
(12) Patent Application Publication
(10) Pub. No.: US 2015/0286860 A1
(43) Pub. Date: Oct. 8, 2015

(54) Method and Device for Generating Data from a Printed Document

(71) Applicant: Le Moustache Club S.L., Madrid (ES)

(72) Inventor: Carlos Ruiz-Tapiador, Madrid (ES)

(73) Assignee: Le Moustache Club S.L., Madrid (ES)

(21) Appl. No.: 14/243,172

(22) Filed: Apr. 2, 2014

(51) Int. Cl. G06K 9/00; G06K 9/46; G06K 9/18

(52) U.S. Cl. CPC G06K 9/00442; G06K 9/18; G06K 9/4604

(57) ABSTRACT

A computer implemented method for retrieving information from printed documents and dumping it into formatted documents like forms or templates; the method is mainly aimed to portable and autonomous electronic portable devices furnished with capture means like cameras; therefore the invention is meant but not limited to its implementation in smartphones. The computer implement method of the invention allows the direct dump of data present on printed documents to a computer system in order to use that data to fill formatted forms or documents, so the user can easily fill forms, more specifically tax or financial forms, in a direct way. It is worth mentioning that the whole method is carried out in the autonomous electronic portable device.

### BACKGROUND

Accounting expenses for either personal or professional purposes is a quite spread activity nowadays.

Personal users need to control expenses for managing the income/outcome balance in their daily life, same happens to families that wish to control and manage their expenses. Large companies or professionals require to control expenses by means of accounting every single expense and the taxes due.

In both cases, whenever a product or service are purchased the client gets a printed document, normally a ticket, invoice or receipt, containing the information needed to carry out the accountancy required to control and manage the income/outcome balance.

The current situation is that tickets and invoices are kept and then, once in front of the computer, relevant data regarding prices, expenses, costs, levies and taxes are manually inserted into an accounting computerised system.

Tickets may be lost or damaged leaving them unreadable and the data may be permanently lost. We also need some time to transfer the data comprised in the paper documents to the accounting system.

This problem is well known; hence JP2005316819 describes how to automatically form a tax payment slip such as national tax in a device and a program for forming a tax payment slip. The tax payment slip formation device forms tax payment slip data for every branch based on data for the amount of tax by branches stored in a deposit interest rate tax determination file, reads data of a branch corresponding to the formed tax payment slip data from an own branch master file, and prints the formed tax payment slip data and the read data for the branch on a designated slip while adjusting the pitch to the width of a printing column on the slip. In a similar manner U.S. Pat. No. 8,606,665 discloses an automated system and method for acquiring tax data and importing it into tax preparation software. Tax documents are acquired electronically in a tax data acquisition process by scanning, faxing, or emailing them. Once a tax document is in electronic format, an optical character recognition (OCR) software process obtains tax data from the electronic tax document. Each piece of tax data that is obtained from the OCR software process is then imported into tax preparation software. Once the tax data has been imported into tax preparation software, the software may be used to complete a tax return. An important step in the tax return preparation process is automated so the need for tax professionals to spend time entering tax data into tax preparation software is reduced and data entry errors are reduced. Tax professionals may devote more time to preparing tax returns and less time to data entry.

The problem is that the solutions available by now require the use of a computer network and a server; it would be desirable to have a solution that is both feasible and autonomous so the data required to manage and control expenses and taxes are generated in real time without the need of communication networks.

### DESCRIPTION OF THE INVENTION

The method of the invention is based on the capture, recognition, processing and safekeeping of accounting documents. More precisely the invention is aimed to a computer implemented method for generating formatted data for a formatted accounting document comprising formatted fields.

I another aspect of the invention an electronic portable device adapted to perform cited method is hereby described. Said electronic portable device is furnished with input means, storage means and at least a processing unit; the latter being in charge of performing he step required to carry out the method for generating formatted data for a formatted accounting document comprising formatted fields of the invention.

The computer implemented method hereby described bases its operation on the use of portable electronic devices like cell phones or smart phones and which may have Internet access to access a centralized information repository and a Web Portal that guarantees instant access to the information.

Printed documents containing accounting information are captioned, digitalized and processed in order to extract accounting data that will be used to fill accounting documents.

The implementation of the method hereby described can be deployed in at least three different segments:
Registration of the households incomes and expenses (Domestic Economies)
Registration of the expenses making the companies' Note of Expenses
Registration of invoices and tickets oriented to the generation of professional accounting for Self-Employed Workers.

Each module is directed to its respective segment:
Domestic Economies module that enables the registration of a household's incomes and expenditures.
Note of Expenses module that enables the management of the costs of the companies' workers and reporting of Note of Expenses
Professional Economies Module that enables to manage the activity of a Self-employed Worker.

The Module for Domestic Economies is aimed to non-professional users, allows having a more professional control of their accounts, being able to capture documents the same way as from the module for Professional Economies.

Once a user the module of Domestic Economies, he/she can observe the display of his/her profile, where the user can check quickly and easily, using an analog chart, the overall state of his/her economy, that is to say, the difference of the expenses respect to the incomes. Thus, the green zone of the indicator says that the user have not yet reached a limit set by the difference between incomes and expenses. By contrast, the red zone indicates that expenditures exceeded incomes.

Additionally, information of the last captured document will be available, in order to not duplicate screenshots that may lead to errors in the calculation on its balance sheet.

On the budget management screen, the customer will be able to enter estimated expenses or incomes in each of the types of expenses and incomes of the family unit.

This allows generating the budget status report where the real situation of income and expenses is presented compared to the estimated budget showing the percentages of deviation in each row.

These reports generate PDF documents produced by the Web Services server and displayed on the mobile device.

The module of Professional Economies Module (Entrepreneurs), is specifically aimed to self-employed workers.

On the module's main screen (Profile) a summary of the client's activity, to date, is shown. The last captured document is shown, as well as the summary of the period's profit and loss statement. Since this module is designed, developed and implemented for professional economies, prior to being able to use it, the application requires that a professional profile is created.

When registering the professional profile, the user must enter all information related to the professional activity. These data are:
Tax Identification Number
Country of the accounting
Address and contact details
Date of last taxation
Professional Activities (IAE)
If the professional has leasehold (rented premises) incomes.
If the professional receives invoices from professionals
If the professional has hired staff
In the case of Spain, if the professional operates in the Canary Islands

This information is what makes up the professional's tax profile and will be used in the process of generating accounting entries to produce the correct customer accounting.

Once registered, the profile can be changed when the professional's fiscal situation changes, by using the Settings screen.

Reports generated can be sent to the customer's email address specified by the customer.

### DESCRIPTION OF THE DRAWINGS

To complement the description being made and in order to aid towards a better understanding of the characteristics of the invention, in accordance with a preferred example of practical embodiment thereof, a set of drawings is attached as an integral part of said description wherein, with illustrative and non-limiting character, the following has been represented:

FIG. 1.—Shows a flow diagram of the method of the invention.

FIG. 2.—Shows a workflow diagram of the image process procedure.

### DETAILED DESCRIPTION

In order to carry out the method hereby described a customer must first get registered in a system by creating a unique user code.

The customer may work with a Households module, professional module or note of expenses module. These three modules are independent and the information entered in one of them cannot be used in the other two.

The mode of operation of the three modules is the same. The difference is in the way of processing the information. In the case of households, there is no VAT treatment and the reports generated are adapted to the management of a domestic economy. In the case of the module of Note of Expenses there is no VAT treatment and the main report is a sheet of expenses designed to inform companies of expenses incurred by their staff. Finally, the professional module is oriented towards the management of the Self-Employed Workers accounting. In this module there is VAT treatment and the reports generated contemplates the official books and tax models suitable to each professional profile included in the application.

In all modules, the system's main operation cycle is as follows:
capturing at least an image of a document by means of capturing means of a portable electronic device,
recognising data from the image by means of an OCR process by means of a processing unit of the portable electronic device,
extracting the data from the image by means of a processing unit of the portable electronic device,
recognising the data assigning, by means of a processing unit of the portable electronic device, correct accounting entries associated with the document,

The captured image is normalized and the required information of metadata and a security HASH is generated; then the image is processed by OCR incorporating intelligent elements such as geolocation data regarding the geographical location of the image captured and attaching geolocation data to the data extracted from the image or learning and pattern applications, for improving accuracy in a large number of cases. The resulting characters recognized are cleaned, sorted and processed by applying algebraic algorithms that detect the relationship between numbers. This process identifies the appropriate fields of an invoice and produces a valid structure.

The resulting information may be validated by the customer and the accounting entries, suitable to his profile, are automatically generated then the recognized data and accounting entries are packaged, and sent to the Web Services server using Secure HTTPS connection for safekeeping.

The Web Services server verifies the validity of the image and incorporates the document and its information into the database and the centralized document repository. For this purpose, it incorporates the metadata to the image and includes the digital signature.

With the unique user code of the user, the user has access to a web portal accessible from the Internet through which it is possible to access all the information stored in the Invention's database and document repository. This Web Portal provides immediate access to the documents, including the possibility to search for any particular property of the document, as well as visualize the associated images and metadata, verify its integrity and obtain information regarding the digital signature.

Additionally, the system provides for regular closures of the database, either as an order from the customer or by automatic processes for deadlines regarding the expiration of tax filing dates.

The first action the user should do when using the application is to get registered in the system, or if previously registered, enter the username and password (login) in order to enter the application. The Signing Up and Login process is carried out jointly between the portable electronic device, and a Web environment through a WebServices server.

The process is as follows:
Signing Up
   On the electronic portable device, the minimum data required for getting registered is requested:
      Name
      Email address
      Password
      Acceptance of Terms of Use
   This information is sent to the Web Services server in order to get the client registered into the Invention Environment
   The Web Services Server sends an email to the customer with an activation code. This is done to avoid a massive registration of users and for validating the user's email address.
   When the customer uses the activation code by using a link provided in the email sent by the system, the user is activated and, by default, a Household accounting is created associated to the user code (email).
Login Process
   Once the user is registered and gets activated, the user can use the application's functionalities. For this purpose, it's necessary to enter the user ID (email) and password to enter.
   When the user enters the username and password, this information is validated by the Web Services server. If it is correct, an internal code is assigned to the mobile device that will keep the session open for the time the client wishes. This internal code is invalidated when the customer makes “logout” of the application, or when the user's password is changed. In these cases, the user must re-login.
In addition, as part of the login process, the client is provided with options for:
   Resending the activation email
   Remembering and Changing the Password. At no time the user password is sent by email. If the user does not remember the password, the system will send the user an email with a link in order to change the password by himself.

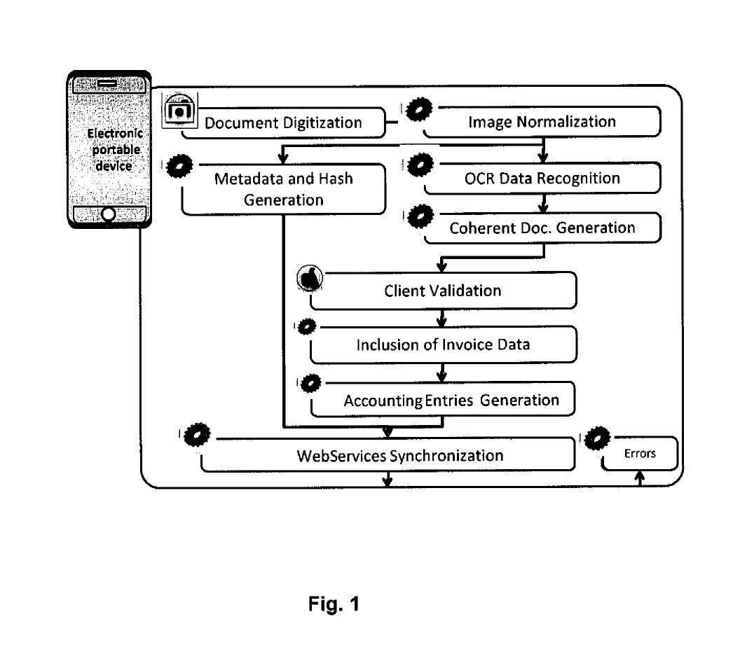

In a preferred embodiment of the invention depicted in FIG. 1, a computer implemented method for generating formatted information hereby described starts with the capture of an image of a document; caption enabled by means of capturing means of a portable electronic device, i.e. a mobile device's camera. This can be done by clicking on the camera icon that appears in the upper right corner of the screen; when clicking on the camera, the document digitizing process starts; it may be required to indicate a type or nature of the document to be digitized.

The image is picked up by the camera of the electronic portable device; since the image may be taken from different types of documents the method hereby described embraces different ways of managing the document images. Consequently, when the document is a ticket the user may select an area of the image and link it to a determined field of the formatted document; in this aspect of the method of the invention the user may follow three different paths that render three different embodiments of the invention.

In a first embodiment the user may tap on a certain point of the screen showing the image and the processing unit of the portable electronic device starts a recognition process based on image contrasts algorithms to determine a window that surrounds a text/characters area so an OCR process will be focus on that area to extract any characters comprised in the window and once processed and extracted, the processed characters will be linked to the field selected by user. In this sense the user may take a picture of a ticket and once the image is shown on the screen of his/her smartphone the user tap on an point of the image related to an amount referred to the TOTAL amount due in the ticket; the area surrounding said point is processed and the characters determined to be comprised in the earlier mentioned windows are extracted by means of the OCR, said characters (once processed) actually are the number referred to the total amount due in the ticket; so the number is linked, and later inserted, to the field TOTAL of the formatted document.

In a second embodiment the user may define a window comprising an area that surrounds a text/characters area. In this case the process differs from the point-based process in that the window is determined by the user so there is no need of defining the window from a point tapped on the screen. The rest of the process remains the same once the window has been defined.

In a third embodiment the user may produce a voice command related to a type of document, name of provider, supplier code or any other item allowing a document to be identified or linked to a template stored in the portable electronic device. Hence the voice command is captured by an audio capturing means of the electronic portable device, the microphone of the cell phone, and once it is processed by a voice recognition algorithm the processing unit of the electronic portable device can define the type of document selected by the user via the voice command and retrieve said type of document from the database of the electronic portable device. Once the document is retrieved from the database, an image of the document retrieved is used as a template masking the image captured by the image pick-up means of the portable electronic device; this acts as a mask showing a plurality of empty fields of the document retrieved from the database on the image captured; so i.e. the field TOTAL is an empty window overlapping a character string of the captured image. At this point the processing unit of the portable electronic device is ready to selectively process those area of the captured image that are bounded by the windows of the fields of the template respectively extracting the data comprised in each area and assigning to the extracted data the respective field of each window of the template. In this way, the user may say “PROVIDER 1”, then the image is captured (this can be done after or before the voice command is produced) and a template related to “PROVIDER 1” is retrieved from the database and processed along the captured image; for every window of the template that is related to a field of the formatted document the method will process the content of the areas of the captured image that are related to every window or the template, extract the data of said areas and assign every piece of data extracted and processed from the captured image to each field of the formatted document defined by the template retrieved from the database of the portable electronic device.

When the user goes online every single data related to the templates or the document database allocated on the portable electronic device is dumped to a remote server; similarly every document that was not matching any template may be converted into a template, in order to do this the user may create a template by either tap or defining windows on the areas of interest on the images captured and then, once online, the template comprising the windows is uploaded to the server.

Depending on the nature of the document, the process of capturing the information may vary. At this point, the system has at least three different processes of information capture for formatted:
Received Invoices
Issued Invoices
Tickets

In the case of Tickets, a simplified process is used, because it is only required to register the date and the document's total amount, besides the nature of the expense.

When the user wants to generate formatted data for a formatted document comprising formatted fields from a document, he selects the appropriate option related to the type of document on the electronic portable device. The digitalization of the document is made by using a camera of the mobile device using the functions of the operating system of the electronic portable device.

The resulting image from the capturing process is post processed and normalized in order to prepare it for a data recognition process by using an OCR. The processes performed to normalize the image are:
Conversion to gray scales
Removal of edges and correction by perspective
Noise Removal
Adjustment to minimum legal resolution

Once the captured image has been normalized, automatically and without intervention by the user, the required metadata is included and a hash is generated to ensure that the image remains complete in the following steps until it reaches the centralized server where all the information will be properly integrated in a document, including the digital signature.

The metadata that is included in the document is:
Name and version of the software
Approval reference
Date and time of digitalization of the document
In addition, by application needs, we include the geographic location where digitalization (latitude and longitude) was performed

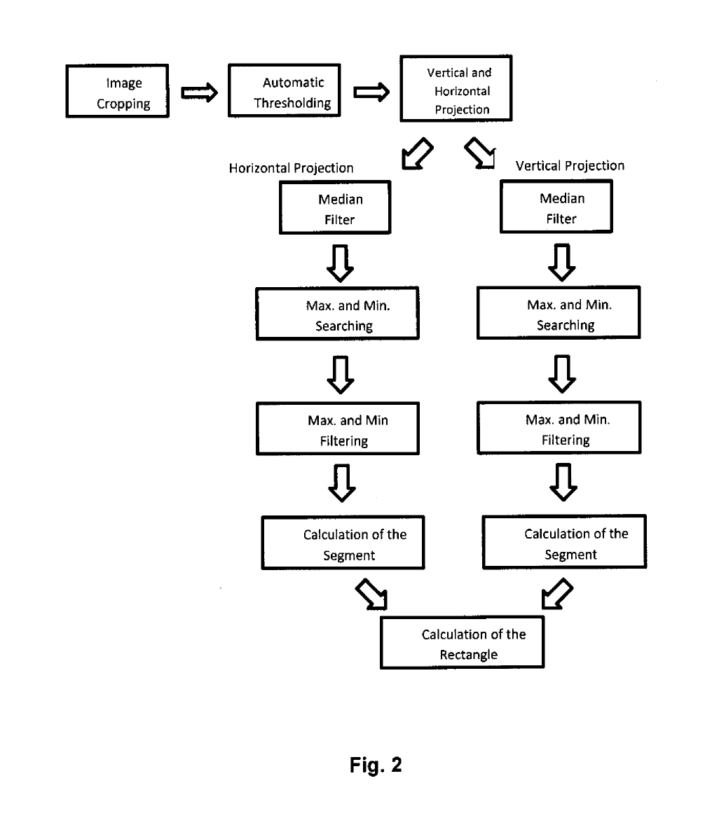

Once the digitized document is normalized, a series of processes depicted in FIG. 2 are set to recognize by OCR the different elements present in the document.

For this, assistance by the user may be required to indicate the location of these elements and improve the accuracy of the processing algorithm. However, in a preferred embodiment of the invention the portable electronic devices comprises a database of templates and formats that may be used to compare the captured image with any element present in said database in order to determine a pattern and directly allocate every single element and its type present in the captured image.

The data to be extracted from the captured and digitized image is associated with the type of document.

For invoices, the data stored in the document is:
Issuer VAT Id
Receptor VAT Id
Document Nature (nature of the income or expense)
Document Date
Tax Base
VAT Fee
Equalization Tax
Income Tax Fee
Invoice's total amount

In the case of Tickets, the data to be extracted is the following:
Nature of the document (type of expenditure)
Document date
Document's total amount

In order to optimize the recognition of the data and facilitate the process of data capture for the client, the system incorporates several intelligent elements for the automatic recognition of the information in a large number of cases.

This information will be stored in the local database on the electronic portable device and could be transferred to a server.

In order to extract the data from the document, the following transformations on the captured images are applied:
Scale change of the photographed image to the size of the pattern image. This transformation is performed for speeding the following processing.
Detection of the characteristic points in both the pattern image and the rescaled image. These characteristic points refers to the geometry and texture of the invoice, and are different in each invoice model to be recognized, but common to the same invoice family. This is to say, the invoice of the company A will differ from the invoice of company B, but all invoices from company A will share the same characteristic points, as well as the invoices of the company B.
Matching of characteristic points. A function that matches the points in an image with another, so that point to point spatial relations between the two images (pattern and rescaled image of the invoice or ticket document) are applied.
Calculation of the matrix that relates the affine transformations (rotation and translation) between the pattern image and the rescaled image (of the invoice or ticket document). With this matrix the positions of the pattern image's fields can be transformed into those that would apply on the rescaled image (of the invoice or ticket document).
Scaling of the positions of the fields of interest calculated on the rescaled image (of the invoice or ticket document) at the original scale of the invoice.

For the detection of the characteristic points of the image, an image processing algorithm called SURF has been used: Speeded-Up Robust Features.

This algorithm is specialized in detecting local features of an image. This is based on an approximation of the matrix:

$$( x , σ ) = [ \begin{matrix}{L}_{xx} ( x , σ ) & {L}_{xy} ( x , σ ) \\ {L}_{xy} ( x , σ ) & {L}_{yy} ( x , σ )\end{matrix} ]$$

using the theory of integral image.

$${I}_{\sum } ( x ) = {\sum }_{i = 0}^{i \leq x} {\sum }_{j = 0}^{j \leq y} I ( i , j )$$

Given a point X (x, y) in an image I, the matrix H (X, σ) in X on the scale a is defined as:

Being Lxx the second derivative of the Gaussian convolution nucleus of the image I at the point X in the direction x, Lxy the second derivative of the Gaussian convolution nucleus of the image I at the point X in the direction x, and the Lyy second derivative of the Gaussian convolution nucleus for the image I in the point X and in the direction y.

The scaled space is divided into octaves. An octave represents a series of response maps to filters that have been obtained by convolution of an image with filters of different sizes. To generate the answers, you start with a filter of a 9×9 size to go sequentially increasing it to 15×15, 21×21 and 27×27. The second octave has filters of 15, 27, 39 and 51. The third of 27, 51, 75 and 99. And so on.

For a description of the features, the SURF algorithm uses the responses (both horizontal and vertical) of Haar Wavelets. A neighborhood of 20s×20s (being “s” the size) and divided into 4×4 sub regions, is used. For each of the sub regions, the horizontal and vertical responses of the Wavelets are taken and a “v” vector is created as follows:

v=(Σdₓ,Σd_{y},Σ|dₓ|,Σ|d_{y}|)

Being dx the response of the horizontal Wavelets and and dy in vertical. The SURF algorithm descriptor may extend to 128 dimensions, that is the size selected in the described algorithm.

To accelerate the matching process, the SURF algorithm incorporates a simple criterion based on sign (a clear point of interest on a dark background or a dark point of interest on a light background) that is used to determine the matching (comparison of the descriptors values)

To perform pairing of points, between the obtained by the pattern image and the ones generated from the image where the pattern is to be positioned, a few algorithms are applied in order to accelerate this step as much as possible.

Along the method discussed above in the description of the SURF algorithm to determine if two points are matchable or not, a matching system based on FLANN (Fast Library for Approximate Nearest Neighbors) is also used. This library contains a set of optimized algorithms for the search of neighbors in large data collections and for large features.

Besides searching for acceleration in points pairing processing, other ways of speeding the pairing stage have been sought. The pattern image and the target image have different dimensions, being the pattern image smaller than the target pattern. In order to expedite the pairing, has opted for to resizing the target image (keeping the scale factor) to the size of the pattern image. Thus, what is achieved is to reduce the number of candidates of characteristic points on the target image while, maintaining sufficient points to ensure the positioning of the pattern in the image.

In order to position the pattern within the target image and being able to perform coordinates correspondences between one image and the other, it is necessary to calculate the affine transformation matrix that relates the two points of view. This is known as Homography matrix, by which it is possible to transform the space of coordinates of a point between both images.

The spatial relationship between a point X to another X ‘is given by the homography matrix H:

$$( \begin{matrix}{x}_{1}^{′} \\ {x}_{2}^{′} \\ {x}_{3}^{′}\end{matrix} ) = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] ( \begin{matrix}{x}_{1} \\ {x}_{2} \\ {x}_{3}\end{matrix} )$$

To calculate the matrix H given two points of view, it is necessary to estimate in both of them the same point, so that, through a series of pairs the inverse calculation of matrix H is possible. To ensure a robust result, it takes more points, so as to establish an oversized system of equations in which an error estimation function, that will have to be minimized, will be presented.

To resolve this problematic the method assumes the following start condition:

cx′=Hx

Where “c” is a constant value, x ‘is a point in space π’ and x its corresponding with space π. H is the homography matrix to be solved.

$${x}^{′} = [ \begin{matrix}u \\ v \\ 1\end{matrix} ] x = [ \begin{matrix}x \\ y \\ 1\end{matrix} ] H = [ \begin{matrix}{h}_{1} & {h}_{2} & {h}_{3} \\ {h}_{4} & {h}_{5} & {h}_{6} \\ {h}_{7} & {h}_{8} & {h}_{9}\end{matrix} ]$$

Developing the matrix equation, you can get to the next system of simple equations:

$$c [ \begin{matrix}u \\ v \\ 1\end{matrix} ] = [ \begin{matrix}{h}_{1} & {h}_{2} & {h}_{3} \\ {h}_{4} & {h}_{5} & {h}_{6} \\ {h}_{7} & {h}_{8} & {h}_{9}\end{matrix} ] [ \begin{matrix}x \\ y \\ 1\end{matrix} ] \begin{matrix}cu = {h}_{1} x + {h}_{2} y + {h}_{3} \\ cv = {h}_{4} x + {h}_{5} y + {h}_{6} \\ c = {h}_{7} + {h}_{8} + {h}_{9}\end{matrix} \\ - {h}_{1} x - {h}_{2} y - {h}_{3} + ( {h}_{7} + {h}_{8} + {h}_{9} ) u = 0 \\ - {h}_{4} x - {h}_{5} y - {h}_{6} + ( {h}_{7} + {h}_{8} + {h}_{9} ) v = 0$$

From each pair of known points, two equations can be extracted, thereby for solving a problem of 8 degrees of freedom like this, you need at least 4 points that provides the 8 minimum equations of resolution needed. For this, it is necessary to know the dimensions of both the image that wants to be resized, and the image that wants to be reached. The following equation applies:

$$Scale = \frac{Real Size}{Pattern Size}$$

To calculate the final dimension (width and height) of the image to be scaled, the one that has the pattern image is assigned as “height”. The scaling factor is calculated by taking into account this dimension of “height”, taking as “real size” the size of the image that wants to be scaled, and as “Pattern size” the size of the pattern image. With this factor the theoretical width that it should have, for not distorting the aspect ratio, is calculated.

Once positioned the areas of the pattern on the scaled image, the inverse relation scale is applied to recover those positions in the real scale factor of the original image.

For optimizing the response of the character recognition algorithm (OCR) it is necessary to provide a clean image where, ideally, only the information of the text to read is. Therefore, it is very important to remove possible edges or text areas adjacent to the texts to be read, even improving the text itself making neater edges, increasing contrast, etc.

The invention also envisages applying an automatic thresholding to determine, within the image, what is background from what is text.

Furthermore, a projection (sum) of all points of the image in a single direction is performed, achieving as result a one-dimensional vector.

To the vector generated by projecting the image of the cut on a line, a median filter to remove ripple from the measurement is applied then, upon the filtered vector, a search from where the local maxima and minima are is performed. Depending on the maximum and average value of the maxima and minima, threshold values are generated by which measures that are not normal are rejected (which will be the unwanted noise zones and edges); once the maxima and the minima are filtered, the ones that define the length of the text segment (first and last minimum) can be selected, being the height for the vertical projection and the width for the horizontal.

In other embodiments of the invention it might be necessary to define the rectangle that contains a word based on a point inside the word itself. To do this,
1. Initial Search Window: Depending on the height and width of the image, a window size for the search of the first character is set.
2. Automatic Thresholding: Applying Otsu's method, an automatic thresholding is performed to determine, within the image, which is background from what is text.
3. Initial letter search: With the search window defined in the first step, the height of the character of the word to be processed, by a system of projections on the vertical, are calculated. Analyzing the maxima and minima of the signal, the character height is delimited.
4. Word Search: Depending on the height of the character found, a passing size is defined, with which the search window will be moving to the left and right of the initial point. Analyzing the distribution of text areas in that window, the stopping criterion will be established.
5. Search Tuning: Once the width of the word is determined, we proceed to a system of tuning in height of the found word. This method solves potential problems that may appear in words with characters of different heights such as the case of upper and lower case. The upper and lower limits of the frame will be scrolling pixel by pixel until not finding any text on its edge line.

Since the OCR itself may produce erroneous information product of changing conditions in terms of brightness and image noise, or due to confusion of characters and digits; the method of the invention accounts for:
Processing and recognition of character strings
Generation of coherent documents by applying Algebraic Algorithms (identification of the algebraic relationships between numbers).

The first step in the process of improving the information consists of the processing of the character strings produced by the OCR process. This is accomplished by cleaning of non relevant characters at the beginning and the end of the data recognized.

Next, the character string is processed by making substitutions of letters for digits or vice versa considering the most common errors produced by the OCR, based on the extensive tests performed. For example, the OCR can recognize the character ‘|’ or the letters'l ‘or’ I ‘instead of the digit ‘1’.

The process of recognition of character string is done adjusting the type of data required. This is necessary because it is very different if the data that is being recognized is alphanumeric as the suppliers VAT Id, or if it is a Date field, or if it is a numeric field. In the case of the VAT Id, the basic structure of the VAT Id is used taking into account that the first and last character can be a letter or a number and the rest must be numeric digits. Additionally, in case of not getting a valid VAT Id according to the VAT Id validation formula, they are checked against the list of third parties registered in the device for identifying the one that most closely matches and is proposed as recognized data.

In the case of dates, it is also taken into account the possible structure of this data including the possibility of getting the month in text format (January, February, Jan, Feb, etc.)

Equally done in the case of numeric fields taking special care in the treatment of decimals.

Once the fields have been independently processed, the system applies coherence algorithms to the data by verifying the algebraic relations that should exist between them. For this, the algorithm will verify the relationships and in case of not fulfilling it, will generate all possible scenarios and propose the document closest to the input data that is consistent.

Total=Base+VAT+Surcharge−IncomeTax (1)

If this relationship holds, the document is consistent and is proposed for client validation.

In case that the formula (1) is not met, algebraic relations between the invoice's data are sought. These relationships are sought assuming that there are two of the correct data. If we can find these two data, it is possible to reconstruct the rest of the invoice's data based on them.

The algebraic relations that are verified are as follows:

∃_{% VAT}tq.(VAT=Base* % VAT) (2)

∃_{% Surcharge}tq.(Surcharge=Base* % Surcharge) (3)

∃_{% IncomeTax}tq.(Income Tax=Base* % IncomeTax) (4)

These relationships are searched taking as % VAT, % Surcharge, % Income Tax the values of the following table.

| VAT | Surcharge | |
|---|---|---|
| 21% | 5.2% | Spain Mainland VAT |
| 10% | 1.4% | |
| 4% | 0.5% | |
| 35% | 3.5% | Canary Islands VAT |
| 20% | 2.0% | |
| 13.5% | 1.35% | |
| 9.5% | 0.95% | |
| 7% | 0.7% | |
| 3% | 0.3% | |
| IncomeTax | | |
| 21% | | |
| 19% | | |
| 9% | | |

If a relationship is found between the fee and the base, then a proposal where the total is calculated based on the other fields is generated. The same happens if a relationship between the total and the fee is found:

$$\begin{matrix}{∃}_{\% VAT } tq . ( VAT = ( Total - VAT ) * \% VAT ) {\to }^{yields} Base = \frac{VAT}{\% VAT} & ( 5 ) \\ {∃}_{\% Surcharge} tq . ( Surcharge = ( Total - Surcharge ) * \% Surcharge ) {\to }^{yields} Base = \frac{Surcharge}{\% Surcharge} & ( 6 ) \\ {∃}_{\% IncomeTax} tq . ( IncomeTax = ( Total - IncomeTax ) * \% IncomeTax ) {\to }^{yields} Base = \frac{IncomeTax}{\% IncomeTax} & ( 7 )\end{matrix}$$

Equally between the fee and the surcharge:

$${∃}_{\% VAT} tq . ( \frac{VAT}{\% VAT} = \frac{Surcharge of VAT}{\% ( Surcharge of VAT )} ) {\to }^{yields} Base = \frac{VAT}{\% VAT} \qquad ( 8 )$$

Likewise between the total and the base:

$${∃}_{\% VAT} tq . ( Base + ( Base * \% VAT ) = Total ) {\to }^{yields} VAT = Base * \% VAT \qquad ( 9 )$$

If a relationship between two numbers recognized is not found, then the customer will be requested to select the document's total amount. This will give us a reliable data that we will use for proposing a document that we will reconstruct based on the VAT and Income Tax percentage associated with the nature of the document and the user profile:
Has:
   Nature VAT
   Nature Income Tax
   Total Amount
Base Formula:

Base=Total/(1+% VAT−% Income Tax)

Fee=Base* % VAT

Income Tax=Base* % Income Tax

Total=Base+Fee−Income Tax

Similarly, if the client is in Equalization Tax, additionally, the surcharge associated with the Nature VAT is used:

Base=Total/(1+% VAT+% Surcharge−% IncomeTax)

Fee=Base* % VAT

Surcharge=Base* % Surcharge

IncomeTax =Base* % IncomeTax

Total=Base+Fee+Surcharge−Income Tax

These relationships between the numbers present in the document allow the identification of the different fields needed to correctly process such document.

In any case, the result of the recognition and processing of the data will be presented to the client for validation or manually change, if necessary.

Once validated by the customer, the system generates accounting entries associated with the recognized document.

To generate accounting entries associated with an entered document, the associated accounting profile with the customer with the nature of the document introduced is matched.

Suppose the user we are working with is in a prorate basis:
leases_premises=true;
canary_islands=false;
iae_exempt=true;
iae_taxable=true;
mod_{—}111_{—}190=true;
mod_{—}115_{—}180=true;
mod_{—}303_{—}390=true;
mod_{—}420_{—}42.5=false;
not_susceptible_surcharge=true;
Professionals=true;
prorate=true;
surcharge=false;
susceptible_surcharge=true;
type=9;
workers=true;

Now suppose that the document to account is as follows:

```
{
    “@f_doc”:  “2013.11.20T00:00”,
    “@nat”: 4,
    “@base”: 850.00,
    “@cuota_iva”: 178.5,
    “@pc_iva”: 0.21,
    “@cif_nif”: “12345678Z”,
    “@total”: 1028,25
}
```

Additionally, suppose that the supplier 12345678Z is the supplier number 15 in the accounting named “SUPPLIER 1”.

The nature of the selected document is “Transport elements”, which book account is 218000000.

For that user, and with the selected nature, we generate:

| FACT | ACCT_VAR | ACCT_COD | CONTRA_VAR | CONTRA | CONCEPT | TYPE | AMM_VAR |
|---|---|---|---|---|---|---|---|
| 25 | @nat | 000000000 | | | S/Fra. - | D | @base |
| | | | | | \|@nom_ter | | |
| 25 | @nat | 000000000 | | | S/Fra. - | D | @cuota_igic |
| | | | | | \|@nom_ter | | |
| 25 | @nat | 000000000 | | | S/Fra. - | D | @cuota_iva |
| | | | | | \|@nom_ter | | |
| | | | | | @pc_iva\|% | | |
| 25 | @pc_iva | 472000000 | @num_prov | 400000000 | TAX | D | @cuota_lva |
| | | | | | S/\|@nom_ter | | |
| | | | | | TAX.non | | |
| 25 | @pc_iva | 631900000 | | | Deductible | D | @cuota_lva |
| | | | | | \|@pc_iva\|% | | |
| 25 | @num_prov | 400000000 | | | S/Fra. - | H | @total |
| | | | | | \|@nom_ter | | |
| 25 | @num_prov | 400000000 | | | S/Fra. | D | @total |
| | | | | | \|@nom_ter | | |
| 25 | | 570000000 | | | N/P | H | @total |
| | | | | | \|@nom_ter | | |

| FACT | ACCT_VAR | ACCT_COD | APLY_PCT | TAX_TYPE | TAX_PCT | BASE | ADJUST |
|---|---|---|---|---|---|---|---|
| 25 | @nat | 000000000 | 1 | | | | |
| 25 | @nat | 000000000 | 1 | | | | |
| 25 | @nat | 000000000 | 0.5 | | | | |
| 25 | @pc_iva | 472000000 | 0.5 | TAX | @pc_iva | @base | @pc_prr |
| 25 | @pc_iva | 631900000 | 0.5 | | | | @pc_prr_inv |
| 25 | @num_prov | 400000000 | 1 | | | | |
| 25 | @num_prov | 400000000 | 1 | | | | |
| 25 | | 570000000 | 1 | | | | |

Replacing the information record by record (line to line), and assuming that the proportional percentage of the accounting in question is 30%, we have:

| seat | acct_dt | doc_dt | subacct | contra | concept | invoice | taxp | surp | itp | typo | ammount | base |
|---|---|---|---|---|---|---|---|---|---|---|---|---|
| 1 | 20/11/2013 | 20/11/2013 | 218000000 | | S/Fra. - | | | | | D | 850.00 | |
| | | | | | SUPPLIER 1 | | | | | | | |
| 1 | 20/11/2013 | 20/11/2013 | 218000000 | | S/Fra. - | | | | | D | 0.00 | |
| | | | | | SUPPLIER 1 | | | | | | | |
| 1 | 20/11/2013 | 20/11/2013 | 218000000 | | S/Fra. - | | | | | D | 89.25 | |
| | | | | | SUPPLIER 1 | | | | | | | |
| 1 | 20/11/2013 | 20/11/2013 | 472000021 | 400000015 | 21% TAXS/ | | 21 | | | D | 26.78 | 850.00 |
| | | | | | SUPPLIER 1 | | | | | | | |
| 1 | 20/11/2013 | 20/11/2013 | 631900021 | | TAX.non | | | | | D | 62.48 | |
| | | | | | Deductible 21% | | | | | | | |
| 1 | 20/11/2013 | 20/11/2013 | 400000015 | | S/Fra. - | | | | | H | 1028.50 | |
| | | | | | SUPPLIER 1 | | | | | | | |
| 1 | 20/11/2013 | 20/11/2013 | 400000015 | | S/Fra. - | | | | | D | 1028.50 | |
| | | | | | SUPPLIER 1 | | | | | | | |
| 1 | 20/11/2013 | 20/11/2013 | 570000000 | | N/P SUPPLIER 1 | | | | | H | 1028.50 | |

The accounting date (acct_dt) is calculated based on the document's date.

A Central Server Synchronization handles all communication between the mobile devices and the central information repository. These functions are:
Signing Up and user authentication

The Web Services service manages the registration and authentication of the mobile devices users. The main functions covered by this component are:
User registration
Sending of user activation email
User Authentication
Password change
Initial synchronization of the user's accounting

The Web Services service is also responsible for managing the information of third parties, customers and suppliers, between the central information repository and the devices.

This includes third-party synchronization in the customers accounting, as well as the synchronization of third-parties' master between the central repository and the devices.

When a client enlists a new third party, the web services server provides a consultation service of the third-parties' master that answers the mobile device if the third party has already been registered by another user, including all associated information so there is no need to ask the customer for all the information.

Regularly, especially when introducing a new document, the mobile devices communicate with the Web Services server to keep the documents backed in the system's central repository.

This includes:
Synchronization of the accounting profile associated with the customer's accounting.
Synchronization of third-parties
Synchronization of documents including the captured image, the data recognized and validated by an input of the customer, and the accounting entries generated in the device.

This Invention maintains a repository of documents for all devices. It is here where having the most complete picture of the state of the customers' accounts, and therefore from where generating the correct briefs and reports.

By accessing the central repository of documents and the accounting made up by its accounting entries, the WebServices server offers a number of services to the mobile devices for generating briefs, reports and export documents.

Additionally, the Web Services server provides the functionality of performing an export of accounting entries in proprietary format whenever required. This export is done between two dates given by the customer.

This export consists of the generation of three files:
XDiary file with the accounting entries of the indicated period.
File of remarks or comments associated with the entries included in the XDiary file.
XSubaccount file with the information of third parties' accounts used by the accounting entries in the XDiary file.

Since the export is based on the generation of three files, the service enables mobile devices generate a Zip file with three files and sending them via email to the address indicated by the user.

The final component of the Invention's architecture is the portal of access to the customers' private area. This portal allows a complete, and without delay, access to all customers information.

1. A computer implemented method for generating formatted data for a formatted accounting document comprising formatted fields, the method characterised by:
capturing at least an image of a printed document by means of capturing means of a portable electronic device,
selecting at least one area of the document comprising said area data to be extracted by means of an input generated by the user,
recognising data from the image by means of an OCR process by means of a processing unit of the portable electronic device,
extracting the data from the image by means of a processing unit of the portable electronic device, and
assigning the data , by means of a processing unit of the portable electronic device, respective accounting entries for each one of the formatted fields of the formatted document.

2. The method of claim 1 further comprising processing the image captured by applying at least one process selected from the group comprising:
normalisation, conversion to gray scale, removal of edges, correction by perspective, deskew, noise removal and resolution adjustment.

3. The method of claim 1 further comprising post-processing information produced by the OCR by performing a character cleaning and an intelligent coherence process for reconstructing data based on incomplete data.

4. The method of claim 1 further comprising generating a security HASH and metadata for the captured image.

5. The method of claim 3 further comprising sending the data and the captured image to a server.

6. The method of claim 4 further comprising applying a digital signature to the data and the captured image.

7. The method of claim 1 further comprising a validation of the fields assigned and linked by means of a manual validation carried out by a user of the portable electronic device.

8. The method of claim 1 further comprising accessing a web portal, by means of a communication module of the portable electronic device, for incorporating the data into a central database and a centralized document repository.

9. The method of claim 1 further comprising generating geolocation data regarding the geographical location of the image captured and attaching geolocation data to the data extracted from the image.

10. The method of claim 1 further comprising filling the formatted document with the generating formatted information.

11. The method of either claim 1 further comprising:
scale changing of the captured image to a size of a pattern image,
detecting characteristic points in both the pattern image and the rescaled image,
matching of characteristic points, wherein spatial relations between the pattern and rescaled images are applied,
calculating a matrix that relates the affine transformations selected from:
rotation and translation, between the pattern image and the rescaled image, and
scaling the positions of the fields of interest calculated on the rescaled image at the original scale of the formatted document comprising formatted fields.

12. The method of claim 1 further comprising processing of character strings produced by the OCR process, said processing comprising in turn:
cleaning of non relevant characters at the beginning and the end of the data recognized,
generating at least one character string from the characters cleansed in the previous step,
processing a character string by making substitutions of letters for digits or vice versa considering known errors produced by the OCR, and
applying coherence algorithms to the data by verifying the algebraic relations that should exist between them and reconstructing the document's data from partial information produced by the OCR process.

13. The method of claim 1 wherein the data is extracted using at least one template stored in the electronic portable device.

14. An electronic portable device comprising input means, storage means and at least a processing unit wherein the processing unit is operative to:
capture at least an image of a document by means of capturing means of a portable electronic device,
recognise data from the image by means of an OCR process by means of a processing unit of the portable electronic device,
extract the data from the image by means of a processing unit of the portable electronic device, and
assign the data, by means of a processing unit of the portable electronic device, respective accounting entries for each one of the formatted fields of the formatted document.

15. The electronic portable device of claim 14 wherein the processing unit is operative to process the captured image.
